(19) United States
(12) Patent Application Publication
(10) Pub. No.: US 2013/0148670 A1
(43) Pub. Date: Jun. 13, 2013

(54) METHOD OF RESOURCE ALLOCATION AND RESOURCE ARBITRATOR

(71) Applicant: Shu-Hsin Chang, Tainan City (TW)

(72) Inventor: Shu-Hsin Chang, Tainan City (TW)

(73) Assignee: INDUSTRIAL TECHNOLOGY RESEARCH INSTITUTE, Hsinchu (TW)

(21) Appl. No.: 13/452,950

(22) Filed: Apr. 23, 2012

(30) Foreign Application Priority Data
Dec. 7, 2011 (TW) 100145060

(51) Int. Cl. H04L 12/28

(52) U.S. Cl. 370/431

(57) ABSTRACT

A method of resource allocation and a resource arbitrator for allocating a resource to one or more users are provided. The method includes the following steps: selecting one of the users according to a sequence; determining an available amount of the selected user according to a benefit amount of the selected user in the current selected turn; determining a service amount of the selected user according to a requirement amount and the available amount of the selected user and allocating the resource to the selected user according to the service amount; accumulating a system benefit level or a benefit amount of each user in a subset of the users according to a residual amount obtained by subtracting the service amount from the available amount, and a weight of each user in the subset; and repeating all of the above steps to allocate the resource to the one or more users.

### CROSS-REFERENCE TO RELATED APPLICATION

This application claims the priority benefit of Taiwan application serial no. 100145060, filed on Dec. 7, 2011. The entirety of the above-mentioned patent application is hereby incorporated by reference herein and made a part of this specification.

### BACKGROUND

1. Field

The disclosure relates to a method of resource allocation and a resource arbitrator.

2. Description of Related Art

A centralized time-division multiplexing (TDM) system includes a resource arbitrator and a plurality of users. The resource arbitrator manages a fixed number of one or a plurality of resources, and allocates the limited resources to the users. For each of the resources, at most one user is allowed to use such resource at any time point, and the other users have to wait. For example, a task schedule arranged for a plurality of programs by a processor, or upstream bandwidth allocation arranged for a plurality of network devices or users by a network server, which all belong to the TDM system.

One kind of the TDM resource allocation modes is the interleaved polling-based scheme. In such mode, the system serves each of the users in a round-robin manner, and a system service cycle can be defined as a service period that takes any user as a start point for serving one turn, for example, in a service process for serving 10 users in the round-robin manner, the service cycle can be consecutive service periods from the user 1 to the user 10, or can be consecutive service periods from the user 5 to the user 10 plus from the user 1 to the user 4. According to such mode, the system can allocate an individual service amount to a single user according to the user's requirement, instead of allocating the resources for an entire service cycle after gathering the requirements of all of the users.

The weighted max-min fairness principle is one of the most widely-adopted concept of resource allocation in the current TDM system. According to the weighted max-min fairness principle, the system can fairly allocate the resources according to the requirements and the weights of the users, make full use of the residual resource, and provide each user a predictable minimum resource usage amount and a maximum service delay.

A heuristic method of resource allocation for achieving the max-min fairness principle is a water-filling procedure. According to the procedure, the service amounts of all users start from 0. Then they are equally increased until the requirement of any user is satisfied, and now the service amount of the satisfied user is frozen, and the above step is repeated to equally increase the service amounts of all unsatisfied users until the resource is exhausted, or the requirements of all of the users are satisfied.

In an embodiment of FIG. 1, the system includes seven users, and each user i demands a requirement amount of rᵢ. In the process of equally increasing the service amount R of each user, the requirement of the user 3 is first satisfied, and the service amount thereof is first frozen, and then the service amounts of the other six users are continuously and equally increased. Then, the requirement of the user 2 is satisfied, and the service amount thereof is frozen, and then the requirement of the user 5 is satisfied, and the service amount thereof is frozen, and deduced by analogy. When the resource is exhausted, the unsatisfied users 1, 4, 6 and 7 all receive the same service amount.

A conventional resource allocation method of the weighted max-min fairness principle is referred to as a limited service scheme. According to such method, the resource arbitrator initially sets a maximum service amount for each user according to its weight. Then, the resource arbitrator selects each of the users in a round-robin manner and allocates the resource to the user. The service amount received by the user in each selected turn is the minimum one of the requirement amount and the maximum service amount thereof FIG. 2 is a diagram illustrating a service timing of an example of the limited service scheme. In this example, it is assumed that three users share the system resource. The upper part 210 is a reference service timing configured according to the maximum service amounts of the users, and the lower part 220 is a resource allocation result calculated with reference of the actual requirements of the users. In the reference service timing 210, the selected user i sends a service request message Rᵢ for a next cycle, and uses the resource within an exclusive service time Dᵢ of a current cycle, and keeps a time gap Gᵢ after the service time is ended. The resource arbitrator allocates a service time of the user in the next cycle after it has received the service request message Rᵢ.

According to the above method, when the requirement amounts of the users are relatively low, the overhead required for switching service among users is accordingly increased, which causes waste of the resource and energy. For example, in a service timing 220 of FIG. 2, it is assumed that the requirement amounts of the user 1 and the user 2 are all 0. Therefore, the service amounts of the user 1 and the user 2 are 0, and the service amount of the user 3 is at most the maximum service amount. According to the service timing 220, it is known that compared to the reference service timing 210, the proportion of the service time Dᵢ of the users in a service cycle is substantially decreased, so that the effective utilization of the system resource is decreased. An extreme situation is that when the requirement amounts of the three users are all 0, as that shown in a service timing 230, the service cycle is entirely occupied by the service request messages and the time gaps, and the transceivers of the resource arbitrator and the users have to intensively process the request messages and the response messages, which causes a great amount of power consumption.

### SUMMARY

The disclosure is directed to a method of resource allocation and a resource arbitrator for a centralized time-division multiplexing (TDM) system, by which a resource of the TDM system is allocated according to a weighted max-min fairness principle, so as to improve the utilization of system resource and guarantee a quality of service for each user. Moreover, the method of resource allocation and the resource arbitrator of the disclosure have a low calculation complexity.

The disclosure provides a method of resource allocation, which is adapted to allocate a resource to one or a plurality of users, and the method of resource allocation includes following steps. One of the users is selected according to a sequence. An available amount of the selected user is determined according to a benefit amount of the selected user in the current selected turn. A service amount of the selected user is determined according to a requirement amount and the available amount of the selected user, and the resource is allocated to the selected user according to the service amount. When the available amount of the selected user is greater than the service amount, a system benefit level or a benefit amount of each user in a subset of the one or the plurality of users is accumulated according to a residual amount, which is obtained by subtracting the service amount from the available amount, and a weight of each user in the subset. All of the above steps are repeated to allocate the resource to the one or the plurality of users.

The disclosure provides a resource arbitrator, which is adapted to allocate a resource to one or a plurality of users. The resource arbitrator includes a storage device and a processor. The processor is coupled to the storage device, and iteratively selects one of the users according to a sequence, determines an available amount of the selected user according to a benefit amount of the selected user in the current selected turn, determines a service amount of the selected user according to a requirement amount and the available amount of the selected user, and allocates the resource to the selected user according to the service amount. When the available amount of the selected user is greater than the service amount, the processor accumulates a system benefit level or a benefit amount of each user in a subset of the one or the plurality of users according to a residual amount, which is obtained by subtracting the service amount from the available amount, and a weight of each user in the subset. The processor uses the storage device to store the weight of each user and either the system benefit level or the benefit amount of each user.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an example of a conventional water-filling resource allocation procedure.

FIG. 2 is a schematic diagram of an example of a conventional limited service scheme.

FIG. 3 is a schematic diagram of a method of limiting a service switching frequency according to an embodiment of the disclosure.

FIG. 4 is a schematic diagram of a method of not limiting a service progress offset according to an embodiment of the disclosure.

FIG. 5 is a schematic diagram of a method of limiting a service progress offset according to an embodiment of the disclosure.

FIG. 6 is a schematic diagram of a method of allocating a residual amount according to weights of users according to an embodiment of the disclosure.

FIG. 7 is a flowchart illustrating a method of resource allocation according to an embodiment of the disclosure.

FIG. 8 is a flowchart illustrating a detailed method of calculating a service amount of a selected user according to an embodiment of the disclosure.

FIG. 9 is a flowchart illustrating a detailed method of allocating a residual amount according to weights of users according to an embodiment of the disclosure.

FIG. 10 is a flowchart illustrating another detailed method of allocating a residual amount according to weights of users according to an embodiment of the disclosure.

FIG. 11 is a flowchart illustrating a method of resource allocation according to another embodiment of the disclosure.

FIG. 12 is a schematic diagram of a resource arbitrator according to an embodiment of the disclosure.

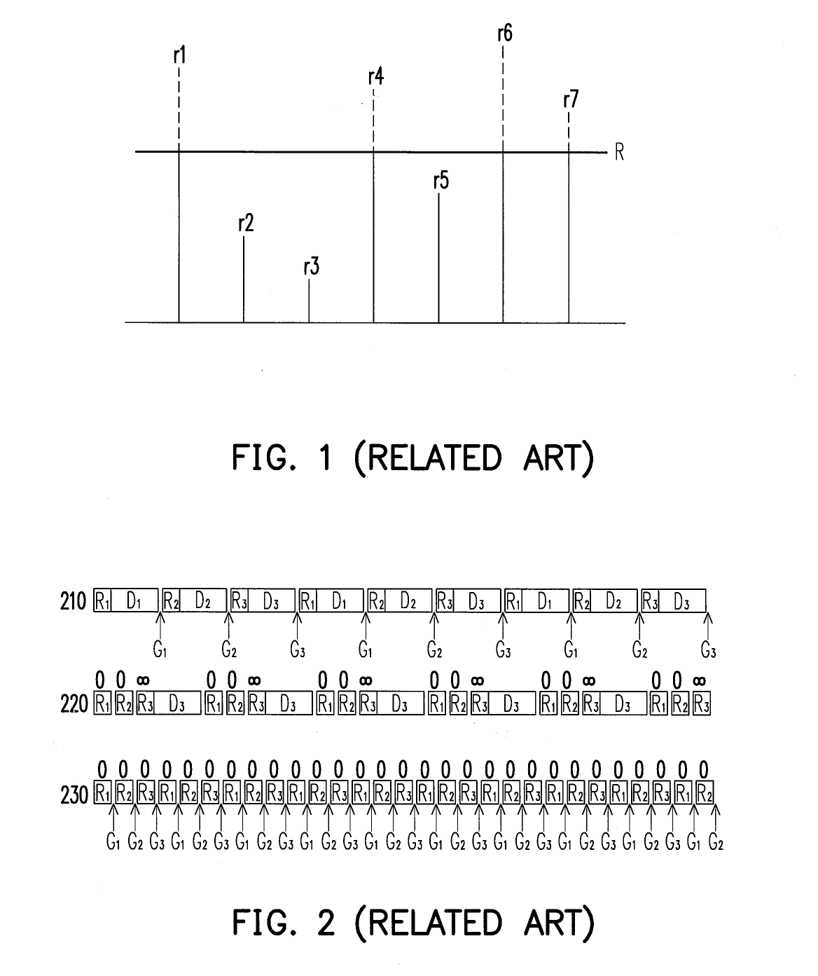

### DETAILED DESCRIPTION OF DISCLOSED EMBODIMENTS

An embodiment of the disclosure provides a method of resource allocation, which is adapted to a centralized time-division multiplexing (TDM) system. The TDM system is composed of a resource arbitrator and a one or a plurality of users. The resource arbitrator selects one of the users according to a sequence in each selecting turn, determines a service amount of the user in the current selecting turn according to a requirement amount of the user and a resource usage history, and allocates an exclusive service time for the user in each of the resources according to the service amount, and then switches to select the next user according to the sequence.

The user can individually use each of the resources provided by the TDM system in its exclusive service time corresponding to the resource, and the other users have to wait for their own exclusive service time. For example, the TDM system can be a multi-core central processing unit (CPU), and each of the users can be a software program. Each of the software programs can individually use the computational resource of a processing core in the CPU within its exclusive service time corresponding to the processing core. Alternatively, the TDM system can be an optical communication system or a network system, and each of the users can be a fibre therein, a wired transmitter, a wireless transmitter, or a data queue corresponding to a service level in the transmitter, which can individually use the upstream bandwidth of a channel in the optical communication system or the network system within its exclusive service time corresponding to the channel for data transmission.

In the TDM system, switching service among users causes performance overhead in resource allocation. For example, the overhead may be a context switch time of the CPU, or a guard time or a request message which consumes the bandwidth of an Ethernet passive optical network (EPON) system.

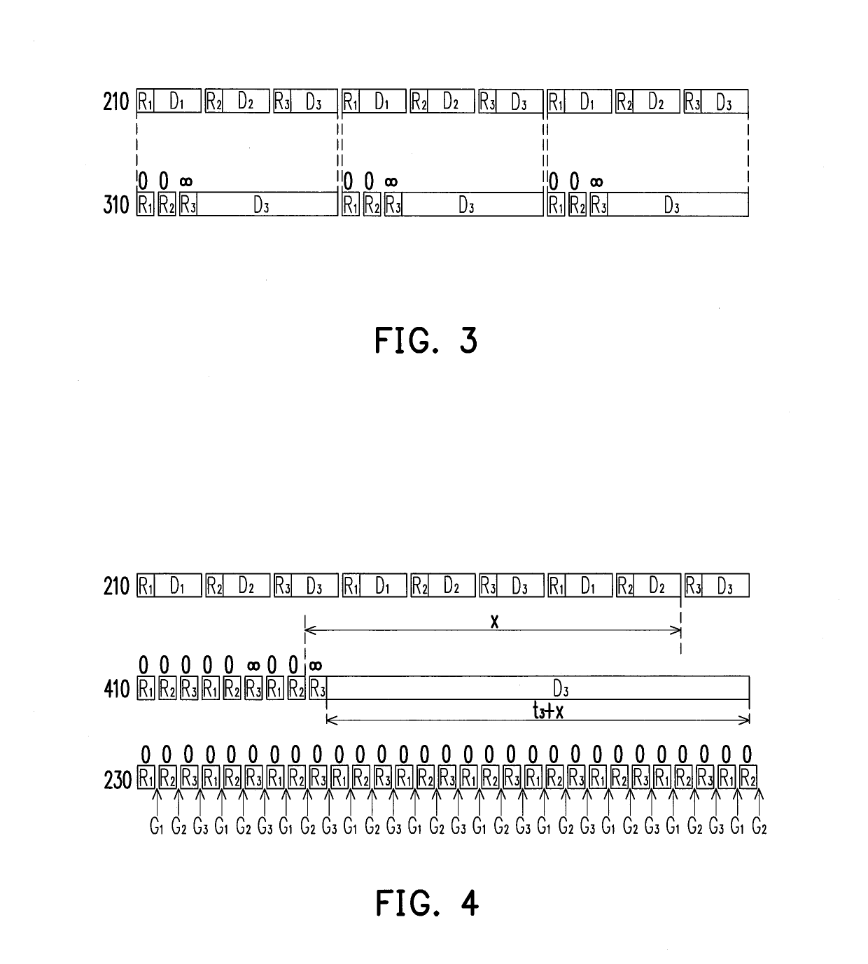

FIG. 3 to FIG. 6 are schematic diagrams of service timings of a plurality of resource allocation examples according to an embodiment of the disclosure. The so-called service timing refers to a resource usage status in a plurality of service cycles arranged according to a time sequence, which includes the overhead and service time of each of the users. The service cycle refers to a time period that the system serves each of the users for one turn, and the start point of a service cycle can be from the service start time of any of the users. Since the system resources are dynamically allocated according to the requirements of users and the resource allocation history, the length of each service cycle is variable. In FIG. 3 to FIG. 6, three users are taken as an example for descriptions, though the disclosure is not limited thereto, and the method of the disclosure is adapted to any number of the users.

A reference service timing 210 in FIG. 3 to FIG. 6 is a comparison scale for various resource allocation examples. The so-called reference service timing is a service timing obtained by deducting the overhead from a predetermined standard resource amount per cycle, and then calculating the service amounts of users by allocating the remained applicable resource amount (which is referred to as a standard service amount per cycle hereinafter) to the users according to the weights of the users, and arranging the service amounts of the users and the overhead according to a sequence. Wherein, the standard resource amount per cycle is the resource amount the system provides within one standard service cycle, and the standard service cycle refers to any service cycle of the reference service timing 210. In the reference service timing 210, the overhead includes the time occupied by R₁-R₃ and G₁-G₃, where R₁-R₃ are respectively a service request message sent to the resource arbitrator by each of the three users, and each of the service request message contains a resource amount (which is referred to as a requirement amount hereinafter) required by the user in a next service cycle. G₁-G₃ are respectively a guard time corresponding to each of the three users, and D₁-D₃ are respectively an exclusive service time belonging to the three users.

The method of resource allocation of the disclosure can improve the effective utilization of the system resources. In one method, the residual resource of each user is reallocated to the users with high requirement amounts in a next service cycle. As shown by a service timing 310 of FIG. 3, in each of the service cycles, the requirement amounts of the user 1 and the user 2 are all 0, while the user 3 demands an extremely large requirement amount, so that the service amounts of the user 1 and the user 2 are reallocated to the user 3. Based on to the above method, despite the variation of users' requirement amounts, the average resource usage amount in one service cycle always approximates to that of the reference service timing 210. In this way, the overhead caused by switching service among users is controlled, so as to improve the effective utilization of the resources. Furthermore, such method can reduce the power consumption of transceivers in a network transmission system.

The method of resource allocation of the disclosure can provide a latency upper bound to each of the users waiting for service. In one method, a service progress offset between the actual service timing and the reference service timing is limited. The so-called service progress offset refers to a difference in the accumulated resource usage amounts corresponding to an identical service switching point in the reference service timing 210 and the actual service timing. For example, in the service timing 410 of FIG. 4, aligned to the service start point of the user 3 in the third service cycle, a service progress offset thereof is x. Moreover, x represents an accumulation amount of the residual resource in the previous resource allocation. Some resource allocation methods do not limit the service progress offset, as that shown in the service timing 410. In the previous two service cycles, the requirement amounts of the three users are all 0. In the third service cycle, the requirement amounts of the user 1 and the user 2 are still 0, while the user 3 demands an extremely large requirement amount. Then the previously accumulated residual resources x are all allocated to the user 3, so that the user 3 obtains a resource usage amount of t₃+x, where t₃ is the service amount assigned to the user 3 within one standard service cycle. During the exclusive service time of the user 3, the user 1 or the user 2 that demands a service requirement can not receive any service at all. Therefore, an excessive service progress offset leads to an unacceptable service latency, where the service latency refers to the delay time from the time when a user generates a resource requirement to the time when the user starts to receive service.

According to the resource allocation method of the service timing 410, in the network transmission system, when the requirement amounts of all of the users are all 0, the users have to send the request messages to the resource arbitrator continuously, and the resource arbitrator has to send the response message in high speed, as that shown in a service timing 230. The process may cause power consumption at the transceivers and waste of upstream and downstream bandwidths.

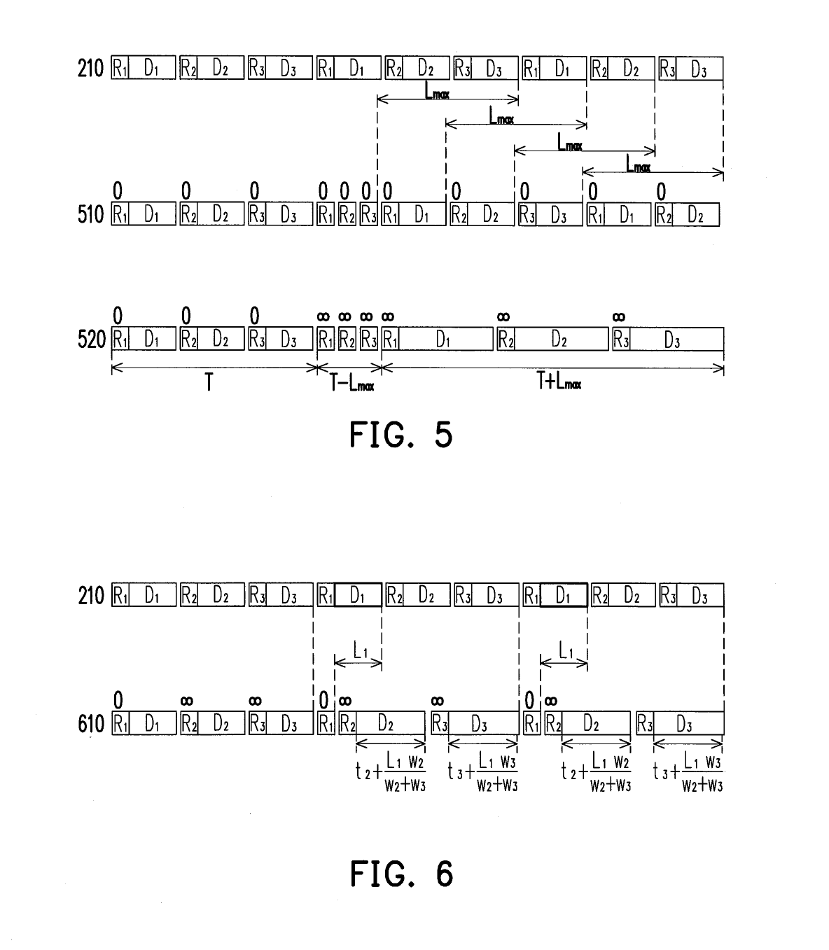

In the method of resource allocation of the disclosure, an upper bound on service latency is guaranteed to each of the users by limiting the service progress offset. One method is to set a parameter Lₘₐₓ, named maximum service progress offset, and enforce the service amount of each user i in each service cycle to be greater than or equal to t₁−(Lₘₐₓ−L), where tᵢ is the service amount assigned to the user i within one standard service cycle, i is a positive integer from 1 to N, N is the total number of the users, and L is a current service progress offset. In this way, the service progress offset is limited within a range not exceeding the maximum service progress offset Lₘₐₓ, as that shown by a service timing 510 of FIG. 5. Moreover, such method also limits the resource usage amount in each service cycle within a range between T−Lₘₐₓ and T+Lₘₐₓ, where T represents a standard resource amount per cycle. Therefore, a maximum service latency is guaranteed to each of the users, so as to avoid power consumption caused by excessive switching of the service among users in an idle state of system.

The method of resource allocation of the disclosure is conformed to the weighted max-min fairness principle. One method is to allocate the residual service amount (which is referred to as a residual amount hereinafter) of each user to the users in need in their next selected turn according to a weight ratio. Referring to a service timing 610 of FIG. 6, started from the second service cycle, a service amount L₁ (assuming L₁=t₁) of the user 1 remains unused in each cycle, and the resource residual amount is allocated immediately to the succeeding selected user 2 and user 3. According to the weight ratio, the extra service amount allocated to the user 2 and the user 3 are τ₂=L₁w₂/(w₂+w₃) and τ₃=L₁w₃/(w₂+w₃) respectively. In this way, started from the second service cycle, the service amount of the user 2 is t₂+τ₂, and the service amount of the user 3 is t₃+τ₃, where tᵢ is the service amount assigned to the user i within one standard service cycle, and wᵢ is the weight of the user i.

The method of resource allocation of an embodiment of the disclosure is described in detail below with reference of flowcharts and equations. In a system initial stage, a basic amount of each user is determined according to a predetermined standard resource amount per cycle, wherein the basic amount refers to the service amount assigned to a user within one standard service cycle. A method thereof is to first deduct the overhead (for example, R₁-R₃ and G₁-G₃ in the reference service timing 210) from the standard resource amount per cycle T, where the remained standard service amount per cycle represents the effective resource that can be used to serve the users within one standard service cycle, and then determine the basic amount of each user according to the standard service amount per cycle, so that the sum of the basic amounts of users are equal to the standard service amount per cycle. For example, the standard service amount per cycle can be allocated according to the weight ratio of the users to serve as the basic amount of each user, which is represented by a following equation (1):

$${t}_{i} = ( T - N \cdot ( r + g ) ) \cdot {w}_{i} / {\sum }_{j = 1}^{N} {w}_{j} \qquad ( 1 )$$

Wherein, i is an index of the user, which is a positive integer between 1 and N, and N is the total number of the users. tᵢ represents the basic amount of user i. T represents the standard resource amount per cycle. r and g represent the overhead introduced each time when a next user is selected for service, where r corresponds to R₁-R₃ in the reference service timing 210, and g corresponds to G₁-G₃ in the reference service timing 210. wᵢ represents the weight of user i. The basic amount of each user calculated according to the equation (1) is proportional to the weight of the user.

The basic amounts of the users are only required to be calculated for once in the system initial stage, and they can be retrieved for use through executing the method of resource allocation of the embodiment.

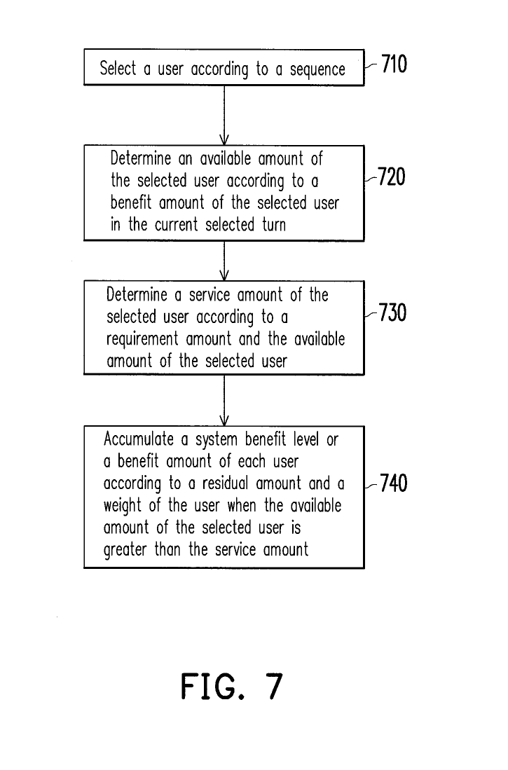

FIG. 7 is a main flowchart illustrating a method of resource allocation according to an embodiment of the disclosure. First, one of the users is selected according to a sequence (step 710). An available amount of the selected user is determined according to a benefit amount of the selected user in the current selected turn (step 720). A service amount of the selected user is determined according to a requirement amount and the available amount of the selected user (step 730), and the resource is allocated to the selected user according to the service amount. The sequence used for selecting the user can be a fixed sequence, or can be dynamically adjusted according to the requirement amount and/or the available amount of the user. Here the requirement amount corresponds to a resource amount the selected user expects to receive in a new service cycle, the available amount corresponds to an upper bound of the resource amount that can be allocated to the selected user in the service cycle, and the service amount is a resource amount that is actually allocated to the selected user in the service cycle.

Then, if the available amount of the selected user is greater than the service amount of the selected user, a system benefit level or a benefit amount of each user in a subset of the one or the plurality of users in its next selected turn is accumulated according to a residual amount of the selected user and a weight of each user in the subset (step 740). Then, the procedure returns to the step 710 to select a next user according to the aforementioned sequence, and the steps 710 to 740 are repeated. The residual amount is a remained resource amount of the selected user in the service cycle, which can be obtained by subtracting the service amount of the selected user from the available amount of the user.

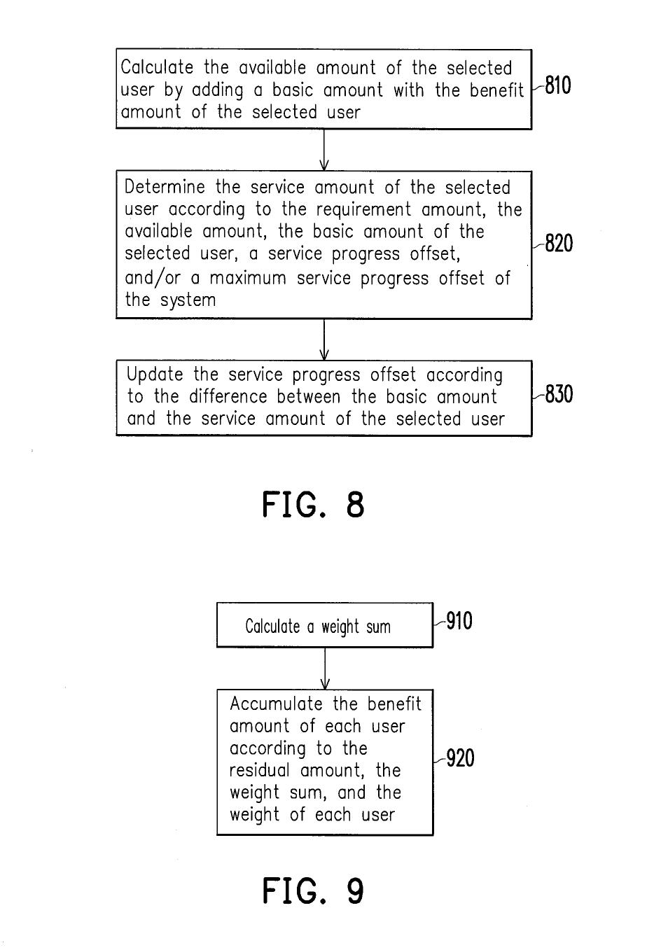

FIG. 8 is a flowchart illustrating a detailed method of calculating the service amount of the selected user in the steps 720 and 730 according to an embodiment of the disclosure. First, a following equation (2) is used to calculate the available amount of the selected user (step 810):

dᵢ(k)=+tᵢ+pᵢ(k) (2)

Wherein, k is the index of a service cycle, which is a positive integer counted from 1. i is the index of the selected user. tᵢ represents the basic amount of user i, dᵢ(k) represents the available amount of the user i selected at a k^{th} service cycle, and pᵢ(k) represents the benefit amount of the user i selected at the k^{th} service cycle.

Then, the service amount of the selected user is determined according to the requirement amount and the available amount of the selected user. Furthermore, it can be determined according to the basic amount of the selected user, a service progress offset and a maximum service progress offset of the system (step 820). The service amount of the selected user can be calculated according to a following equation (3):

sᵢ(k)=max{min{qᵢ(k),dᵢ(k)},tᵢ+L(N×(k−1)+i)−Lₘₐₓ} (3)

Wherein, sᵢ(k) represents the service amount of the user i selected at the k^{th} service cycle. qᵢ(k) represents the requirement amount of the user i selected at the k^{th} service cycle. L(N×(k−1)+i) represents the service progress offset of the system when the user i is selected at the k^{th} service cycle. Lₘₐₓ represents the maximum service progress offset, for example, Lₘₐₓ is set as the aforementioned standard service amount per cycle. max is a maximum value function, and min is a minimum value function.

Then, a following equation (4) is used to update the service progress offset (step 830).

L(N×(k−1)+i+1)=L(N×(k−1)+i)+tᵢ−sᵢ(k) (4)

Wherein, L(N×(k−1)+i+1) represents a new service progress offset of the system when the user i is selected at the k^{th} service cycle and after the service amount of user i is calculated. The new service progress offset when a certain user is selected at a certain service cycle is regarded as the service progress offset when a next user is selected and before the service amount of the next selected user is calculated. The service amount sᵢ(k) calculated according to the above equation achieves the requirement of controlling the resource usage amount in each service cycle and limiting the maximum service latency of each user as that shown in FIG. 5.

In the step 740 of FIG. 7, it is determined whether the available amount of the selected user is greater than the service amount, and if yes, a system benefit level or a benefit amount of each user in a subset of all of the users is accumulated according to a residual amount of the selected user and a weight of each user in the subset. The subset may include all of the users. Alternatively, the subset may include the users with a state of “active” in all of the users. A definition of the user state is as that shown in a following equation (5):

aᵢ(k)=(qᵢ(k)>tᵢ)?1:0 (5)

Wherein, aᵢ(k) represents a new state of the user i selected at the k^{th} service cycle and after the service amount of user i is calculated. For each user i, the new state of the user selected at the k^{th} service cycle is regarded as an old state of the user selected at the (k+1)^{th} service cycle and before the service amount thereof is calculated. According to the equation (5), if the requirement amount of a user is greater than the basic amount of the user, the new state of the user is “active” (with a value of 1), otherwise, the new state of the user is “inactive” (with a value of 0).

Another definition of the user state is as that shown in a following equation (6):

aᵢ(k)=(qᵢ(k)>dᵢ(k))?1:0 (6)

According to the equation (6), if the requirement amount of a user is greater than the available amount of the user, the new state of the user is “active”, otherwise, the new state of the user is “inactive”.

The method of resource allocation of the embodiments of the disclosure can select one of the two aforementioned variations of the subset according to application requirement, and can select the equation (5) or (6) to define the user state according to the application requirement.

FIG. 9 is a flowchart illustrating a detailed method of allocating the residual amount according to the weights of the users in the step 740 according to an embodiment of the disclosure. First, a weight sum is calculated according to a following equation (7) (step 910):

W(N×(k−1)+i)=W(N×(k−1)+i−1)+wᵢ×(aᵢ(k)−aᵢ(k−1)) (7)

Wherein, W(N×(k−1)+0 represents a weight sum of all of the users in the subset when the user i is selected at the k^{th} service cycle and after the service amount of user i is calculated. The weight sum when a certain user is selected at a certain service cycle is regarded as an old weight sum when a next user is selected and before the service amount of the next selected user is calculated. According to the equation (7), if the old state of the user i selected at the k^{th} service cycle is 0 and the new state is 1, the weight sum is set as the old weight sum+wᵢ. Conversely, if the old state is 1 and the new state is 0, the weight sum is set as the old weight sum−wᵢ.

Then, a benefit amount of each user in its next selected turn is accumulated according to the residual amount of the selected user, the weight sum W, and the weight of each user in the subset (step 920). Assume that i is the index of the currently selected user, j is the index of a certain user in the subset, the benefit amount of the user j in its next selected turn is accumulated as that shown in a following equation (8):

pⱼ+=(dᵢ−sᵢ)×wⱼ/W (8)

Wherein, pⱼ represents the benefit amount of the user j in its next selected turn, (dᵢ−sᵢ) represents the residual amount of the currently selected user i. According to the equation (8), the residual amount of the selected user i is allocated to each user j in the subset according to the weight ratio to serve as the benefit amounts of user j in its next selected turns.

The following table 1 provides an example to explain the flowcharts and related equations of FIG. 7, FIG. 8 and FIG. 9. It is assumed that four users share the system resources, weights of the user 1, the user 2, the user 3 and the user 4 are respectively 1, 2, 3 and 4, and the standard service amount per cycle is set to 100. According to the equation (1), the basic amounts of the four users are respectively 10, 20, 30 and 40. In the present embodiment, the users are selected according to a sequence in increased order of indexes, and the user state is defined according to the equation (5), and the four users are all initially set to the “active” state, and the weight sum thereof is 10.

TABLE 1

| User | 1 | 2 | 3 | 4 | 1 | 2 | 3 | 4 | 1 | 2 | 3 | 4 |
|---|---|---|---|---|---|---|---|---|---|---|---|---|
| Weight | 1 | 2 | 3 | 4 | 1 | 2 | 3 | 4 | 1 | 2 | 3 | 4 |
| Basic | 10 | 20 | 30 | 40 | 10 | 20 | 30 | 40 | | | | |
| amount | | | | | | | | | | | | |
| Requirement | 15 | 25 | 9 | 45 | 15 | 21 | 35 | 30 | | | | |
| amount | | | | | | | | | | | | |
| Available | 10 | 20 | 30 | 52 | 14 | 28 | 30 | 48 | | | | |
| amount | | | | | | | | | | | | |
| Service | 10 | 20 | 9 | 45 | 14 | 21 | 30 | 30 | | | | |
| amount | | | | | | | | | | | | |
| Residual | 0 | 0 | 21 | 7 | 0 | 7 | 0 | 18 | | | | |
| amount | | | | | | | | | | | | |
| State | 1 | 1 | 0 | 1 | 1 | 1 | 1 | 0 | | | | |
| Weight sum | Benefit amount | | | | | | | | | | | |
| 10 | (0) | +0 | +0 | +0 | +0 | | | | | | | |
| 10 | | (0) | +0 | +0 | +0 | +0 | | | | | | |
| 7 | | | (21) | +12 | +3 | +6 | +0 | | | | | |
| 7 | | | | (7) | +1 | +2 | +0 | +4 | | | | |
| 7 | | | | | (0) | +0 | +0 | +0 | +0 | | | |
| 7 | | | | | | (7) | +0 | +4 | +1 | +2 | | |
| 10 | | | | | | | (0) | +0 | +0 | +0 | +0 | |
| 6 | | | | | | | | (18) | +3 | +6 | +9 | +0 |

The upper part of table 1 lists the index, the weight, the basic amount of each of the selected users according to a time sequence, and lists the requirement amount, the available amount, the service amount, the residual amount and the state of the user in each selected turn, where these values can be calculated according to the aforementioned equations. To facilitate expressing the concept of allocating the residual resource according to the weight ratio, the step of controlling the service progress offset is omitted. Therefore, the equation (4) is skipped in the calculation process of resource allocation, and the equation (3) used for calculating the service amount can be simplified as a following equation (9):

sⱼ(k)=min{qᵢ(k),dᵢ(k)} (9)

The leftmost column of the lower part of table 1 lists the values of the weight sum W along with service switching, and the number in parentheses represents the residual amount of the selected user after each turn of resource allocation, and four consecutive values at the right of each of the residual amount represent the benefit amount accumulated to each of the users with the state of “active” by allocating the residual amount according to the weight ratio.

First, in a first service cycle of the user 1, the basic amount thereof is 10, the requirement amount is 15, and the accumulated benefit amount is 0. According to the equation (2), it is known that the available amount is 10; according to the equation (9), it is known that the service amount is 10; according to the equation (5), it is known that the state is 1; and according to the equation (7), it is known that the weight sum is 10. Since the available amount is equal to the service amount, the residual amount is 0, and it is unnecessary to accumulate the benefit amount of the user with the “active” state.

Then, in the first service cycle of the user 2, the basic amount thereof is 20, the requirement amount is 25, and the accumulated benefit amount is 0. According to the equation (2), it is known that the available amount is 20; according to the equation (9), it is known that the service amount is 20; according to the equation (5), it is known that the state is 1; and according to the equation (7), it is known that the weight sum is 10. Since the available amount is equal to the service amount, the residual amount is 0, and it is unnecessary to accumulate the benefit amount of the user with the “active” state.

Then, in the first service cycle of the user 3, the basic amount thereof is 30, the requirement amount is 9, and the accumulated benefit amount is 0. According to the equation (2), it is known that the available amount is 30; according to the equation (9), it is known that the service amount is 9; according to the equation (5), it is known that the state is changed from 1 to 0; and according to the equation (7), it is known that the weight sum is 7. Since the available amount is greater than the service amount, the residual amount is 21. The users with the “active” state include the user 4, the user 1 and the user 2, and according to the equation (8), the benefit amounts of user 4, user 1 and user 2 are respectively accumulated with 12, 3 and 6 in the next selected turns.

Then, in the first service cycle of the user 4, the basic amount thereof is 40, the requirement amount is 45, and the accumulated benefit amount is 12. According to the equation (2), it is known that the available amount is 52; according to the equation (9), it is known that the service amount is 45; according to the equation (5), it is known that the state is 1; and according to the equation (7), it is known that the weight sum is 7. Since the available amount is greater than the service amount, the residual amount is 7. The users with the “active” state include the user 1, the user 2 and the user 4, and according to the equation (8), the benefit amounts of user 1, user 2 and user 4 are respectively accumulated with 1, 2 and 4 in the next selected turn, and the others are deduced by analogy.

The following table 2 expresses the calculation process of resource allocation of the example given in table 1 through notations. By comparing the elements of the benefit amount of each user in table 2, it is known that the accumulated benefit amounts of the adjacent users within one service cycle are composed of a plurality of common items e(x)/W(x), where e(x) and W(x) respectively represent the residual amount and the weight sum after the x^{th} turn of resource allocation. For example, the sum of the common items in the benefit amount of user 2 in the second selected turn is e(2)/W(2)+e(3)/W(3)+e(4)/W(4)+e(5)/W(5). Similarly, the sum of the common items in the benefit amount of user 3 in the second selected turn is e(3)/W(3)+e(4)/W(4)+e(5)/W(5)+e(6)/W(6).

TABLE 2

| User | 1 | 2 | 3 | 4 | 1 | 2 | 3 | 4 |
|---|---|---|---|---|---|---|---|---|
| Weight | w₁ | w₂ | w₃ | w₄ | w₁ | w₂ | w₃ | w₄ |
| Basic | t₁ | t₂ | t₃ | t₄ | t₁ | t₂ | t₃ | t₄ |
| amount | | | | | | | | |
| Requirement | q₁(1) | q₂(1) | q₃(1) | q₄(1) | q₁(2) | q₂(2) | q₃(2) | q₄(2) |
| amount | | | | | | | | |
| Available | d₁(1) | d₂(1) | d₃(1) | d₄(1) | d₁(2) | d₂(2) | d₃(2) | d₄(2) |
| amount | | | | | | | | |
| Service | s₁(1) | s₂(1) | s₃(1) | s₄(1) | s₁(2) | s₂(2) | s₃(2) | s₄(2) |
| amount | | | | | | | | |
| Residual | e(1) | e(2) | e(3) | e(4) | e(5) | e(6) | e(7) | e(8) |
| amount | | | | | | | | |
| State | a₁(1) | a₂(1) | a₃(1) | a₄(1) | a₁(2) | a₂(2) | a₃(2) | a₄(2) |
| Weight sum | Benefit amount | | | | | | | |
| W(1) | e(1) | a₂(0)w₂e(1)/ | a₃(0)w₃e(1)/ | a₄(0)w₄e(1)/ | a₁(1)w₁e(1)/ | | | |
| | | W(1) | W(1) | W(1) | W(1) | | | |
| W(2) | | e(2) | a₃(0)w₃e(2)/ | a₄(0)w₄e(2)/ | a₁(1)w₁e(2)/ | a₂(1)w₂e(2)/ | | |
| | | | W(2) | W(2) | W(2) | W(2) | | |
| W(3) | | | e(3) | a₄(0)w₄e(3)/ | a₁(1)w₁e(3)/ | a₂(1)w₂e(3)/ | a₃(1)w₃e(3)/ | |
| | | | | W(3) | W(3) | W(3) | W(3) | |
| W(4) | | | | e(4) | a₁(1)w₁e(4)/ | a₂(1)w₂e(4)/ | a₃(1)w₃e(4)/ | a₄(1)w₄e(4)/ |
| | | | | | W(4) | W(4) | W(4) | W(4) |
| W(5) | | | | | e(5) | a₂(1)w₂e(5)/ | a₃(1)w₃e(5)/ | a₄(1)w₄e(5)/ |
| | | | | | | W(5) | W(5) | W(5) |
| W(6) | | | | | | e(6) | a₃(1)w₃e(6)/ | a₄(1)w₄e(6)/ |
| | | | | | | | W(6) | W(6) |
| W(7) | | | | | | | e(7) | a₄(1)w₄e(7)/ |
| | | | | | | | | W(7) |

Furthermore, a system benefit level B(x) is defined by a following equation (10).

$$B ( x ) = {\sum }_{u = 1}^{x} \{ e ( u ) / W ( u ) \} \qquad ( 10 )$$

When a user is selected in the x^{th} turn of resource allocation in the system, the sum of the common items e(x)/W(x) in the benefit amount of the user accumulated within one service cycle is equal to the difference of the system benefit levels in the current selected turn and in the previous selected turn of the user, and the value thereof is B(x)−B(x−N), where N is the total number of the users. For example, the sum of the common items in the benefit amount of the user 3 in the second selected turn is B(6)−B(2). Then, the benefit amount of the user accumulated within one service cycle is obtained by multiplying the difference of the system benefit levels by the weight and the state of the user.

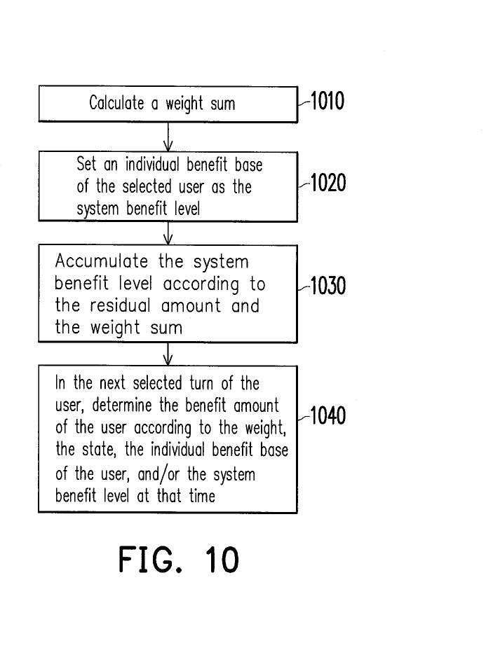

FIG. 10 is a flowchart illustrating another detailed method of allocating the residual amount according to the weights of the users in the step 740 according to an embodiment of the disclosure. FIG. 10 is also a flowchart of a simplified method derived from the aforementioned conclusion of FIG. 9. In the procedure of FIG. 10, a variable referred to as an individual benefit base is additionally maintained for each user in the system. First, the same to the step 910, the weight sum W(x) is calculated (step 1010). Then, the individual benefit base of the selected user is set as the system benefit level B(x) (step 1020), as that shown in a following equation (11):

bᵢ(k+1)=B(N×(k−1)+i) (11)

Wherein, bᵢ(k+1) represents a new individual benefit base of the user i selected at the k^{th} service cycle and after the service amount of user i is calculated. For each user i, the new individual benefit base of the user selected at the k^{th} service cycle is regarded as an individual benefit base of the user selected at the (k+1)^{th} service cycle and before the service amount thereof is calculated. B(N×(k−1)+i) represents an system benefit level when the user i is selected at the k^{th} service cycle and before the service amount thereof is calculated. The system benefit level when a certain user is selected at a certain service cycle is identical to a new system benefit level when the previous user is selected and after the service amount of the previous selected user is calculated.

Then, a following equation (12) is used to accumulate the system benefit level B(x) (step 1030):

B(N×(k−1)+i+1)=B(N×(k−1)+i)+(dᵢ(k)−sᵢ(k))/W(N×(k−1)+i) (12)

Wherein, B(N×(k−1)+i+1) represents a new system benefit level when the user i is selected at the k^{th} service cycle and after the service amount of user i is calculated. The new system benefit level when a certain user is selected at a certain service cycle is regarded as the system benefit level when a next user is selected and before the service amount thereof is calculated. W(N×(k−1)+i) represents the weight sum of all users in the subset when the user i is selected at the k^{th} service cycle and after the service amount thereof is calculated. The meanings of dᵢ(k) and sᵢ(k) have been described in the equation (2) and the equation (3), so the details thereof are not repeated.

Then, when the user is selected for the next turn, the benefit amount of the user accumulated within one service cycle is determined according to the weight, the state, the individual benefit base of the user at that selected turn, and/or the system benefit level at that time (step 1040). For example, when the user i is selected at the k^{th} service cycle, a following equation (13) can be used to calculate the benefit amount of the user:

pᵢ(k)=aᵢ(k−1)×wᵢ×(B(N×(k−1)+i)−bᵢ(k)) (13)

Wherein, pᵢ(k) represents the benefit amount of the user i selected at the k^{th} service cycle. aᵢ(k−1) represents the old state of the user i selected at the k^{th} service cycle and before the service amount of user i is calculated. For each user i, the old state of the user selected at the k^{th} service cycle is identical to the new state of the user selected at the (k−1)^{th} service cycle and after the service amount thereof is calculated. bᵢ(k) represents the individual benefit base of the user i selected at the k^{th} service cycle and before the service amount thereof is calculated. For each user i, the individual benefit base of the user selected at the k^{th} service cycle is identical to the new individual benefit base of the user selected at the (k−1)^{th} service cycle and after the service amount thereof is calculated.

The following table 3 provides an example to explain the flowcharts and related equations of FIG. 7, FIG. 8 and FIG. 10. Assumption conditions including the number of the users, the weight and the basic amount of each user, the service sequence of the users and the requirement amount of each user in each selected turn of the example in the table 3 are all the same to that of table 1, so that the resource allocation results of these two examples of table 1 and table 3 are entirely the same.

TABLE 3

| User | | 1 | 2 | 3 | 4 | 1 | 2 | 3 | 4 |
|---|---|---|---|---|---|---|---|---|---|
| Weight | | 1 | 2 | 3 | 4 | 1 | 2 | 3 | 4 |
| Basic amount | | 10 | 20 | 30 | 40 | 10 | 20 | 30 | 40 |
| Requirement amount | | 15 | 25 | 9 | 45 | 15 | 21 | 35 | 30 |
| Before | State | 1 | 1 | 1 | 1 | 1 | 1 | 0 | 1 |
| allocation | Individual benefit base | 0 | 0 | 0 | 0 | 0 | 0 | 0 | 3 |
| | System benefit level | 0 | 0 | 0 | 3 | 4 | 4 | 5 | 5 |
| After | Benefit amount | 0 | 0 | 0 | 12 | 4 | 8 | 0 | 8 |
| allocation | Available amount | 10 | 20 | 30 | 52 | 14 | 28 | 30 | 48 |
| | Service amount | 10 | 20 | 9 | 45 | 14 | 21 | 30 | 30 |
| | Residual amount | 0 | 0 | 21 | 7 | 0 | 7 | 0 | 18 |

| | | | | | | | | |
|---|---|---|---|---|---|---|---|---|
| State | 1 | 1 | 0 | 1 | 1 | 1 | 1 | 0 |
| Weight sum | 10 | 10 | 7 | 7 | 7 | 7 | 10 | 6 |
| Individual benefit base | 0 | 0 | 0 | 3 | 4 | 4 | 5 | 5 |
| System benefit level | 0 | 0 | 3 | 4 | 4 | 5 | 5 | 8 |

The upper part of table 3 lists the index, the weight, the basic amount and the requirement amount of each of the selected users according to a time sequence. The lower part lists the state, the individual benefit base and the system benefit level before allocating resource to the selected user, and lists the benefit amount, the available amount, the service amount, the residual amount, the state, the weight sum, the individual benefit base and the system benefit level after allocating resource to the selected user. As described above, for each of the selected users, the state and the individual benefit base thereof before the resource allocation are identical to the state and the individual benefit base of the user in the previous selected turn and after the resource allocation, and the system benefit level before allocating resource to the selected user is identical to the system benefit level after allocating resource to the previous selected user. Again, to facilitate expressing the concept of allocating the residual resource according to the weight ratio, the step of controlling the service progress offset is omitted. Therefore, the equation (4) is skipped in the calculation process of resource allocation, and the service amount is calculated according to the equation (9).

First, in the first service cycle of the user 1, the basic amount thereof is 10, and the requirement amount is 15. According to the equation (13), it is known that the benefit amount is 0; according to the equation (2), it is known that the available amount is 10; according to the equation (9), it is known that the service amount is 10; according to the equation (5), it is known that the state is 1; according to the equation (7), it is known that the weight sum is 10; and according to the equation (11), the individual benefit base is set to 0. Since the available amount is equal to the service amount, the residual amount is 0, and it is unnecessary to accumulate the system benefit level.

Then, in the first service cycle of the user 2, the basic amount thereof is 20 and the requirement amount is 25. According to the equation (13), it is known that the benefit amount is 0; according to the equation (2), it is known that the available amount is 20; according to the equation (9), it is known that the service amount is 20; according to the equation (5), it is known that the state is 1; according to the equation (7), it is known that the weight sum is 10, and according to the equation (11), the individual benefit base is set to 0. Since the available amount is equal to the service amount, the residual amount is 0, and it is unnecessary to accumulate the system benefit level.

Then, in the first service cycle of the user 3, the basic amount thereof is 30 and the requirement amount is 9. According to the equation (13), it is known that the benefit amount is 0; according to the equation (2), it is known that the available amount is 30; according to the equation (9), it is known that the service amount is 9; according to the equation (5), it is known that the state is changed from 1 to 0; according to the equation (7), it is known that the weight sum is 7, and according to the equation (11), the individual benefit base is set to 0. Since the available amount is greater than the service amount, the residual amount is 21. According to the equation (12), the system benefit level is accumulated from 0 to 3.

Then, in the first service cycle of the user 4, the basic amount thereof is 40 and the requirement amount is 45. According to the equation (13), it is known that the benefit amount is 12; according to the equation (2), it is known that the available amount is 52; according to the equation (9), it is known that the service amount is 45; according to the equation (5), it is known that the state is 1; according to the equation (7), it is known that the weight sum is 7, and according to the equation (11), the individual benefit base is set to 3. Since the available amount is greater than the service amount, the residual amount is 7. According to the equation (12), the system benefit level is accumulated from 3 to 4, and the others are deduced by analogy.

According to the equations (11), (12) and (13), when the selected user releases the residual resource, the residual amount is normalized and accumulated to the system benefit level, and when the selected user requires an extra resource, a cycle increment of the system benefit level is multiplied with the weight thereof, and the obtained benefit amount is an accumulated value of the residual amounts that are released by all of the users within the a service cycle before the user is selected and are allocated according to the weights. Therefore, according to the method of allocating the residual amount disclosed in FIG. 10 (referring to the example of Table 3), allocation of the residual amounts within a service cycle to a selected user according to the weights only requires fixed times of computation, and a computation complexity thereof is O(1). Comparatively, according to the method of allocating the residual amount disclosed in FIG. 9 (referring to the example of Table 1), the required computation time for allocating the residual amounts within a service cycle to the selected user according to the weights is proportional to the total number N of the users, and a computation complexity thereof is O(N). Therefore, the method of FIG. 10 can effectively reduce the computation complexity of resource allocation.

FIG. 9 and FIG. 10 are flowcharts illustrating detailed methods of the step 740, and the resource allocation results generated according to the above two methods are entirely the same, so that the two methods have the same features of service quality. Moreover, compared to the method flow of FIG. 9, the computation time required by the method flow of FIG. 10 is lower.

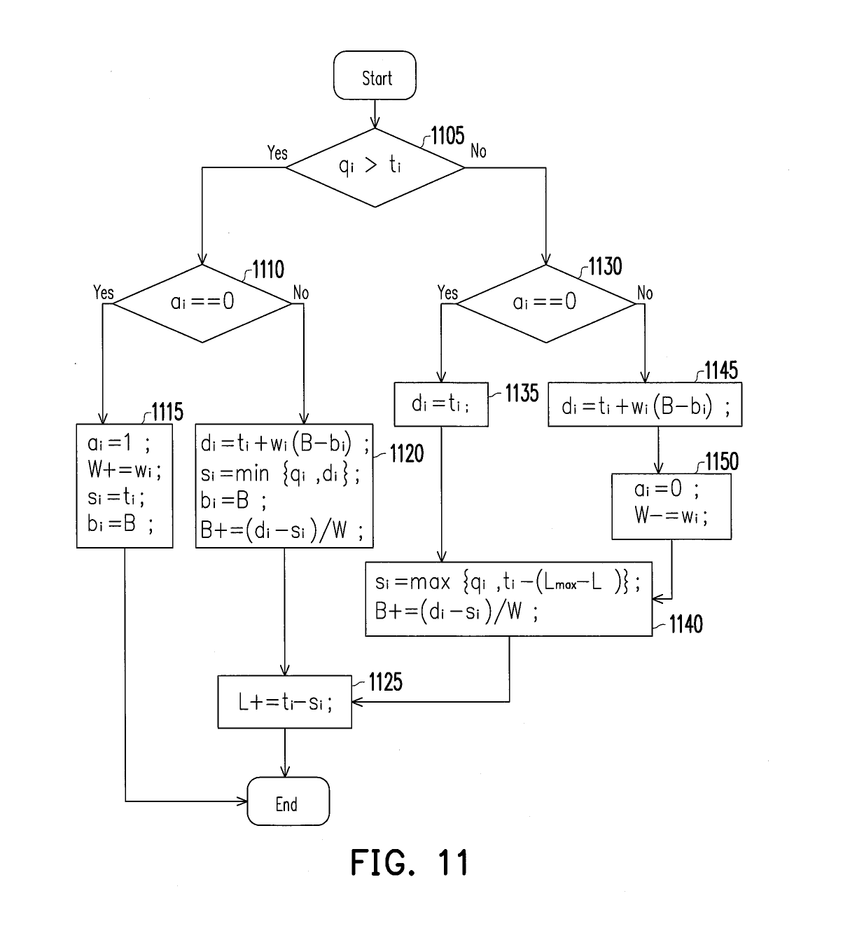

FIG. 11 is a flowchart of a resource allocation method for a selected user according to another embodiment of the disclosure. The method flow of FIG. 11 further simplifies the resource allocation methods of FIG. 7, FIG. 8 and FIG. 10 by skipping some unnecessary calculations under various state conditions of the user. Again, the resource allocation result generated according to the resource allocation method of FIG. 11 is entirely the same to that of the aforementioned embodiments.

The method flow of FIG. 11 is described below. First, it is determined whether the new state of a selected user is “active” or “inactive”, and such step corresponds to check whether the requirement amount qᵢ of the user is greater than the basic amount tᵢ (step 1105). If the new state of the user is “active”, a step 1110 is executed, which determines whether the old state aᵢ of the user is “active” (the value 1) or “inactive” (the value 0). If the old state aᵢ is “inactive”, a step 1115 is executed, by which the new state aᵢ is set to “active”, and simplified equations of the step 1115 are used to update the weight sum W, calculate the service amount sᵢ of the user and set the individual benefit base bᵢ of the user.

If the old state aᵢ of the user is “active” according to the step 1110, simplified equations of a step 1120 are used to calculate the available amount dᵢ and the service amount sᵢ of the user, set the individual benefit base bᵢ and update the system benefit level B. Then, an equation of a step 1125 is used to update the service progress offset.

If the new state of the user is “inactive” according to the step 1105, a step 1130 is executed, which determines whether the old state aᵢ of the user is “active” (the value 1) or “inactive” (the value 0). If the old state aᵢ is “inactive”, a simplified equation of a step 1135 is used to calculate the available amount dᵢ of the user. Then, simplified equations of a step 1140 are used to calculate the service amount sᵢ of the user and update the system benefit level B. Then, the step 1125 is executed.

If the old state aᵢ is “active” according to the step 1130, a simplified equation of a step 1145 is used to calculate the available amount dᵢ of the user. Then, simplified equations of a step 1150 are used to set the new state aᵢ to “inactive” and update the weight sum W. Then, the step 1140 and the step 1125 are executed.

The resource allocation methods disclosed in the aforementioned embodiments serve each of the users in a round-robin manner according to a service sequence, and the service sequence can be a fixed sequence sorted according to the indexes or the weights of the users, or sorted according to other predetermined rules. After the above service sequence is determined, the service sequence of the user can be dynamically adjusted according to computation results of the current states, the requirement amounts and/or the available amounts of the users.

The resource allocation methods disclosed in the aforementioned embodiments can dynamically adjust the standard resource amount per cycle T and the maximum service progress offset Lₘₐₓ according to a service quality requirement of the user, and can dynamically update the weight sum W, and change the weight wᵢ, the state aᵢ, and/or the individual benefit base bᵢ of one or a plurality of users when the requirement of the user is varied.

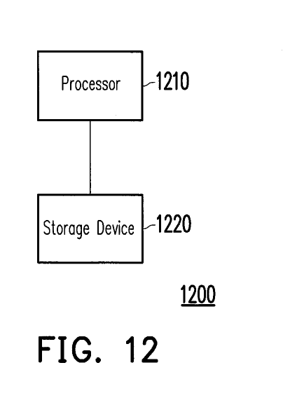

FIG. 12 is a schematic diagram of a resource arbitrator according to an embodiment of the disclosure. The resource arbitrator 1200 includes a processor 1210 and a storage device 1220. The storage device 1220 can be a register or a memory used for storing data. The processor 1210 is coupled to the storage device 1220. The processor 1210 can execute the resource allocation method of each of the aforementioned embodiments to determine the service amount obtained by each of the users in each service cycle. The processor 1210 uses the storage device 1220 to store data that is required to be recorded in the process of executing the aforementioned resource allocation method, for example, the weight wᵢ, the basic amount tᵢ, the state aᵢ, and the benefit amount pᵢ of the user i, and the service progress offset L and the maximum service progress offset Lₘₐₓ of the system.

In summary, the disclosure provides a method of resource allocation and a resource arbitrator used in a centralized time-division multiplexing (TDM) system, in which the overhead of resource allocation is reduced by limiting the service switching frequency, so as to improve the resource utilization of the system, and reduce power consumption of the transceivers. By allocating the residual resources according to the weight ratio of the users, the weighted max-min fairness principle is conformed to, and a minimum resource usage amount for each user is guaranteed. By controlling the service progress offset, the maximum latency each user waiting for service is upper bounded. Moreover, the disclosure also provides a simplified calculation program, which can reduce the computation complexity of the resource allocation method and the resource arbitrator.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method of resource allocation, adapted to allocate a resource to one or a plurality of users, and the method of resource allocation comprising:
selecting one of the users according to a sequence;
determining an available amount of the selected user according to a benefit amount of the selected user in a current selected turn;
determining a service amount of the selected user according to a requirement amount and the available amount of the selected user, and allocating the resource to the selected user according to the service amount;
accumulating a system benefit level or a benefit amount of each user in a subset of the one or the plurality of users according to a residual amount obtained by subtracting the service amount from the available amount, and a weight of each user in the subset when the available amount of the selected user is greater than the service amount; and
repeating all of the above steps to allocate the resource to the one or the plurality of users.

2. The method of resource allocation as claimed in claim 1, wherein the step of determining the available amount of the selected user comprises:
calculating the available amount by adding a basic amount and the benefit amount of the selected user in the current selected turn.

3. The method of resource allocation as claimed in claim 2, wherein the step of determining the basic amount of the selected user comprises:
determining the basic amount of each of the users according to a standard service amount per cycle in a standard resource amount per cycle that is capable of serving the one or the plurality of users in a standard service cycle, such that a sum of the basic amount of the one or the plurality of users is equal to the standard service amount per cycle.

4. The method of resource allocation as claimed in claim 3, wherein the basic amount of each of the users is proportional to the weight of the user.

5. The method of resource allocation as claimed in claim 2, wherein the step of determining the service amount of the selected user comprises:
determining the service amount according to the requirement amount, the available amount, the basic amount, a service progress offset and/or a maximum service progress offset.

6. The method of resource allocation as claimed in claim 5, further comprising:
updating the service progress offset according to a difference between the basic amount and the service amount of the selected user.

7. The method of resource allocation as claimed in claim 2, wherein the subset comprises one or a plurality of the users with a state of “active”, and the state of each of the users is determined according to a comparison result of the requirement amount, the basic amount and/or the available amount of the user.

8. The method of resource allocation as claimed in claim 7, wherein for each of the users, when the requirement amount of the user is greater than the basic amount of the user, the state of the user is “active”, otherwise, the state of the user is “inactive”.

9. The method of resource allocation as claimed in claim 7, wherein for each of the users, when the requirement amount of the user is greater than the available amount of the user, the state of the user is “active”, otherwise, the state of the user is “inactive”.

10. The method of resource allocation as claimed in claim 1, wherein the subset comprises all of the users.

11. The method of resource allocation as claimed in claim 1, wherein the step of accumulating the benefit amount of each user in the subset comprises:
calculating a weight sum, wherein the weight sum is a sum of the weights of all of the users in the subset; and
accumulating the benefit amount of each user in the subset according to the residual amount, the weight sum and the weight of each user.

12. The method of resource allocation as claimed in claim 1, wherein the step of accumulating the system benefit level comprises:
calculating a weight sum, wherein the weight sum is a sum of the weights of all of the users in the subset;
setting an individual benefit base of the selected user as the system benefit level;
accumulating the system benefit level according to the residual amount and the weight sum; and
in a next selected turn of the selected user, determining the benefit amount of the selected user according to the weight of the selected user, the state of the selected user in the next selected turn, the individual benefit base of the selected user in the next selected turn, and/or the system benefit level in the next selected turn of the selected user.

13. A resource arbitrator, adapted to allocate a resource to one or a plurality of users, and the resource arbitrator comprising:
a storage device; and
a processor, coupled to the storage device, iteratively selecting one of the users according to a sequence, determining an available amount of the selected user according to a benefit amount of the selected user in a current selected turn, determining a service amount of the selected user according to a requirement amount and the available amount of the selected user, and allocating the resource to the selected user according to the service amount, wherein when the available amount of the selected user is greater than the service amount, the processor accumulates a system benefit level or a benefit amount of each user in a subset of the one or the plurality of users according to a residual amount obtained by subtracting the service amount from the available amount, and a weight of each user in the subset, and the processor uses the storage device to store the weight of each user and either the system benefit level or the benefit amount of each user.

14. The resource arbitrator as claimed in claim 13, wherein the processor calculates the available amount of the selected user by adding a basic amount and the benefit amount of the selected user in the current selected turn, and the processor uses the storage device to store the basic amount of each of the users.

15. The resource arbitrator as claimed in claim 14, wherein the processor determines the basic amount of each of the users according to a standard service amount per cycle in a standard resource amount per cycle that is capable of serving the one or the plurality of users in a standard service cycle, such that a sum of the basic amount of the one or the plurality of users is equal to the standard service amount per cycle.

16. The resource arbitrator as claimed in claim 15, wherein the basic amount of each of the users is proportional to the weight of the user.

17. The resource arbitrator as claimed in claim 14, wherein the processor determines the service amount according to the requirement amount, the available amount, the basic amount, a service progress offset and/or a maximum service progress offset, and the processor uses the storage device to store the service progress offset and the maximum service progress offset.

18. The resource arbitrator as claimed in claim 17, wherein the processor updates the service progress offset according to a difference between the basic amount and the service amount of the selected user.

19. The resource arbitrator as claimed in claim 14, wherein the subset comprises one or a plurality of the users with a state of “active”, and the processor determines the state of each of the users according to a comparison result of the requirement amount, the basic amount and/or the available amount of the user, and uses the storage device to store the state of each of the users.

20. The resource arbitrator as claimed in claim 19, wherein for each of the users, when the requirement amount of the user is greater than the basic amount of the user, the state of the user is “active”, otherwise, the state of the user is “inactive”.

21. The resource arbitrator as claimed in claim 19, wherein for each of the users, when the requirement amount of the user is greater than the available amount of the user, the state of the user is “active”, otherwise, the state of the user is “inactive”.

22. The resource arbitrator as claimed in claim 13, wherein the subset comprises all of the users.

23. The resource arbitrator as claimed in claim 13, wherein the processor calculates a weight sum, wherein the weight sum is a sum of the weights of all of the users in the subset, and the processor accumulates the benefit amount of each user in the subset according to the residual amount, the weight sum and the weight of each user.

24. The resource arbitrator as claimed in claim 13, wherein the processor calculates a weight sum, wherein the weight sum is a sum of the weights of all of the users in the subset, the processor sets an individual benefit base of the selected user as the system benefit level, accumulates the system benefit level according to the residual amount and the weight sum, and in a next selected turn of the selected user, the processor determines the benefit amount of the selected user according to the weight of the selected user, the state of the selected user in the next selected turn, the individual benefit base of the selected user in the next selected turn, and/or the system benefit level in the next selected turn of the selected user.
